(19) United States
(12) Patent Application Publication
(10) Pub. No.: US 2014/0126216 A1
(43) Pub. Date: May 8, 2014

(54) LIGHT GUIDE

(71) Applicants: Merijn Keser, Eindhoven (NL); Marco Andreas Jacobus Andreas Jacobus Van As, Waalre (NL); Frank Walterus Franciscus Marie Van Kempen, Eindhoven (NL)

(72) Inventors: Merijn Keser, Eindhoven (NL); Marco Andreas Jacobus Andreas Jacobus Van As, Waalre (NL); Frank Walterus Franciscus Marie Van Kempen, Eindhoven (NL)

(73) Assignee: KONINKLIJKE PHILIPS N.V., EINDHOVEN (NL)

(21) Appl. No.: 14/129,360

(22) PCT Filed: Jun. 28, 2012
(86) PCT No.: PCT/IB2012/053273

§ 371 Date: Dec. 26, 2013

(30) Foreign Application Priority Data
Jul. 1, 2011 (EP) 11172400.1

(51) Int. Cl. F21V 7/04

(52) U.S. Cl. CPC F21V 7/041
USPC 362/296.05

(57) ABSTRACT

The disclosed embodiments relate to a light guide (100a) and a luminaire (700) including such a light guide (100a). The light guide (100a) guides light emitted in a first direction (500) from a light source (200) comprising at least one light emitting diode (210). The light guide (100) directs a major part of the light in a second direction (600), wherein the first direction (500) is not equal to the second direction (600). The light guide (100a) comprises a cone part (110a) having a shape of a cone, and a center axis (120) of the cone part (110a) is in the first direction (500). The light guide (100a) can be used with reflectors (800) that have originally been manufactured for use with high intensity discharge lamps or halogen lamps but because of the light guide (100a), the reflectors (800) can be used together with light sources (200) in the form of at least one light emitting diode (210).

### FIELD OF THE INVENTION

The present invention relates to the field of light sources, and more specifically to a light guide.

### BACKGROUND OF THE INVENTION

LEDs (Light Emitting Diodes) or modules comprising LEDs, generate light in the form of a half sphere instead of the omnidirectional light pattern emitted by other present art light sources like HID (High Intensity Discharge) lamps and halogen lamps. A LED light source is also often located at the bottom of a reflector. This makes it necessary to develop reflectors designed specifically for such LED light sources which can be cost and capacity demanding. Furthermore, standard LED light source applications often suffer from glare.

### SUMMARY OF THE INVENTION

It is an object of the present invention to overcome or alleviate problems of the prior art.

According to a first aspect of the invention, this and other objects are achieved by a light guide for guiding light emitted in a first direction from a light source comprising at least one light emitting diode, wherein the light guide is arranged to direct a major part of the light in a second direction, wherein the first direction is not equal to the second direction, wherein the light guide comprises a cone part having a shape of a cone, wherein a center axis of the cone part is in the first direction, and wherein the cone part has a circumferential surface. This is advantageous in that glare is limited since a major part of the light leaves the cone part in the second direction and thus less light comes directly from the light source. Furthermore, because the light travels through the light guide, the light will be mixed to some extent, enabling a more homogeneous beam pattern.

The light emitted from the light source may be arranged to be reflected on the circumferential surface of the cone part such that after the reflection, the light is directed in the second direction.

The circumferential surface may comprise a reflective coating. This is advantageous in that light incident on the circumferential surface that is not reflected by total internal reflection (because the angle of incidence is to small) is reflected.

The reflective coating may be at least one from the group of a specularly reflective, and diffusively reflective. This is advantageous in that the distribution of the light can be made more uniform in terms of brightness.

The circumferential surface may be at least one from the group of segmented and facetted. This is advantageous in that the distribution of the light can be made more uniform in terms of brightness.

The light guide may be arranged to direct a minor part of the light in the first direction. This is advantageous in that there is less loss due to reflection.

A center of the cone part may comprise a through opening such that light emitted from the light source directed to the center of the cone part continues through the cone part in the first direction. This is advantageous in that there is less loss due to reflection.

The cone part may be arranged in a cylinder part in the shape of a cylinder.

The cylinder part may be arranged to provide total internal reflection. This is advantageous in that there is less loss due to reflection.

According to a second aspect of the invention, this and other objects are achieved by a luminaire. The luminaire comprises: a light guide according to anyone of the embodiments under the first aspect.

The luminaire may further comprise a light source comprising at least one light emitting diode (LED). This is advantageous in that it is capacity and cost efficient. Alternatively, the luminaire may comprise a LED lighting module comprising at least one light emitting diode or an array of light emitting diodes. An example of such a LED lighting module are the LED lighting modules being standardized within the standardizing consortium Zhaga.

The light source may further comprise at least one of a mix box and a diffusive exit window. This is advantageous in that properties of the light emitted from the light source can be adjusted.

The luminaire may further comprise a reflector wherein the reflector is adapted for a light source selected from the group of high intensity discharge lamps and halogen lamps. This is advantageous in that the light guide may be used with reflectors that are adapted for light sources selected from the group of high intensity discharge lamps and halogen lamps which is both capacity and cost efficient.

The advantages of the first aspect are equally applicable to the second aspect. Furthermore, the second aspect can be embodied in accordance with the first aspect.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiments of the invention in which,

FIG. 1 is a schematic illustration of a cross-section of an embodiment of the inventive light guide arranged in an embodiment of the inventive luminaire.

FIG. 2 is a schematic illustration of a cross-section of an embodiment of the inventive light guide arranged in an embodiment of the inventive luminaire.

FIG. 3 is a schematic illustration of a cross-section of an embodiment of the inventive light guide arranged in an embodiment of the inventive luminaire.

FIG. 4 is a schematic illustration of a cross-section of an embodiment of the inventive light guide arranged in an embodiment of the inventive luminaire.

FIG. 5 is a schematic illustration of a perspective view of an embodiment of the inventive light guide.

### DETAILED DESCRIPTION

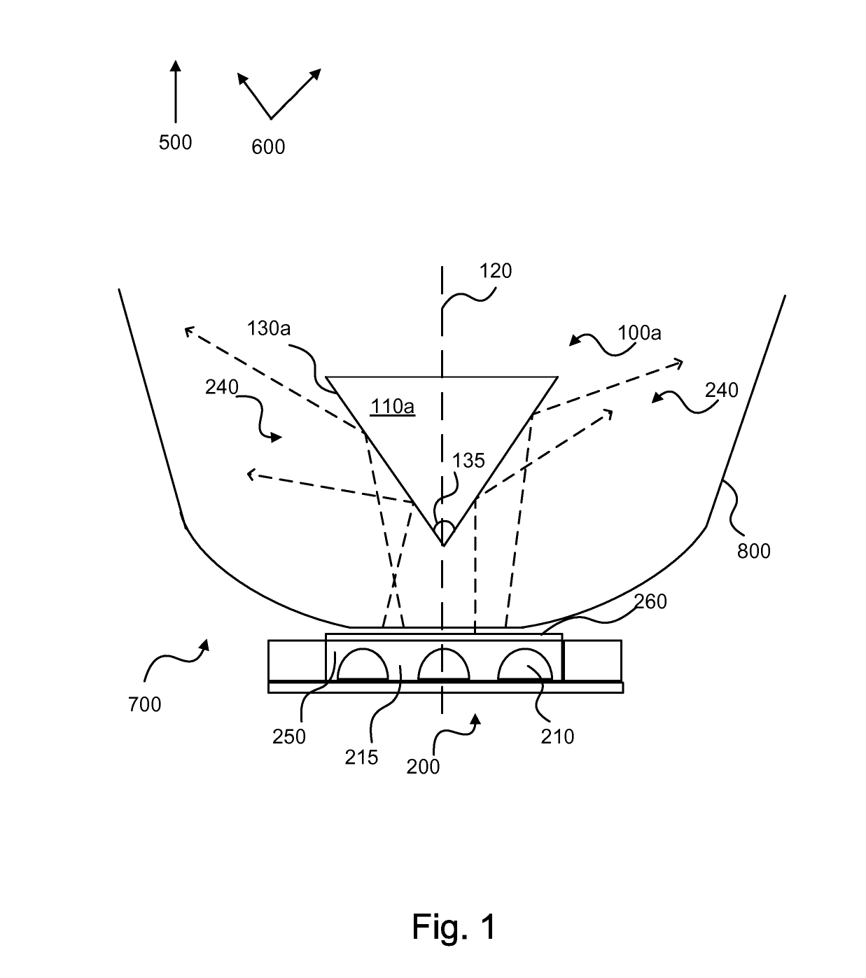

FIGS. 1-4 are schematic illustrations of cross-sections of embodiments of the inventive light guide arranged in an embodiment of the inventive luminaire. Firstly, the features in common will be described jointly with reference to FIGS. 1-4. Secondly, the differences will be described. When referring to, e.g., all embodiments of the light guide, a generic reference, such as 100 will be used. When referring to specific embodiments, specific references, such as, e.g., 100bd will be used.

A luminaire 700 is disclosed comprising a light guide 100, a light source 200 and a reflector 800. The reflector 800 may be adapted for a light source selected from the group of high intensity discharge lamps and halogen lamps. Thus, the reflector 800 may originally be manufactured for use with high intensity discharge lamps or halogen lamps but due to the light guide 100, the reflector 800 can be used together with a light source 200 in the form of at least one light emitting diode 210.

The light source 200 may comprise a light emitting diode module 215 comprising the at least one light emitting diode 210. A diffusive window 260 may be arranged in the light source 200 such that light emitted from the at least one light emitting diode 210 travels through the diffusive window 260. The diffusive window 260 is arranged to spread the light that travels through it which results in more uniform brightness of the light emitted from the light source 200. The light source 200 may also comprise a mix box 250 arranged to mix the light emitted from the light source 200. A mix box is a space surrounded by reflective walls, in which light is reflected multiple times. Due to the multiple reflections, the light can be seen as to originate from any point within this space, thus creating the effect of a single (larger) light source, instead of multiple (small) light sources. The diffusive window 260 may be arranged in front of the mix box 250 and be covered by a diffusive cover.

The light guide 100 has a cone part 110 having a shape of a cone. A center axis 120 of the cone part 110 is in a first direction 500.

Light from the light source 200 is emitted in a semispherical distribution, which is oriented in the first direction 500. The light guide 100 is arranged to direct a major part of the light 240 in a second direction 600, wherein the first direction 500 is not equal to the second direction 600. It is to be noted that the second direction 600 is herein to be interpreted broadly. The second direction 600 can be any direction that is not parallel to the first direction 500.

The cone part 110 has a circumferential surface 130. The light emitted from the light source 200 is arranged to be reflected on the circumferential surface 130 of the cone part 110 such that after the reflection, the light is directed in the second direction 600.

The circumferential surface 130 may comprise a reflective coating. The reflective coating may be at least one from the group of a specularly reflective, and diffusively reflective. The reflective coating can be any type known to the skilled person, e.g., a metallic coating.

The circumferential surface 130 may be at least one from the group of segmented and facetted. This is to be interpreted as that the circumferential surface may be embodied having all sorts of embodiments comprising amounts of facets and/or segments ranging from 0 to infinity. Facets may be distributed along segments. Alternatively, facets may be distributed randomly. The facets and/or segments may be flat. Alternatively, the facets and/or segments may have a corrugated surface.

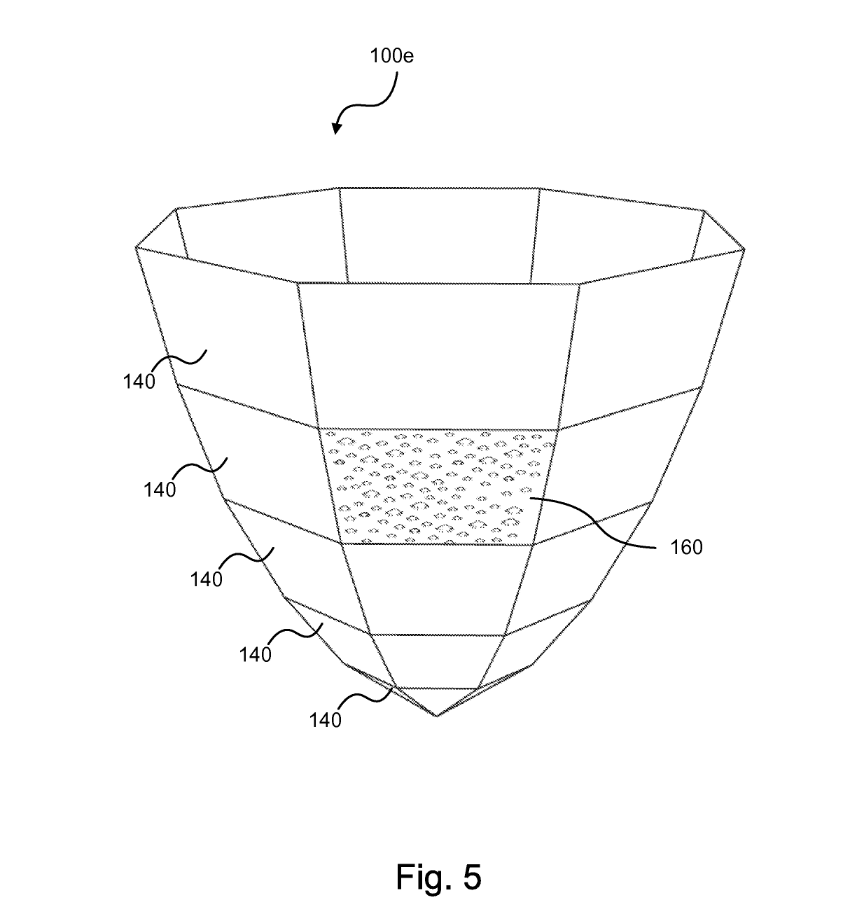

FIG. 5 discloses an embodiment of a light guide. It is to be understood that the features of the light guide 100e are applicable also to the light guides 100abcd. The circumferential surface of the light guide 100e comprises facets and segments. The facets 140 form a segment. The facet 160 has a corrugated surface. It is to be noted that the light guides may be embodied having facets but no segments.

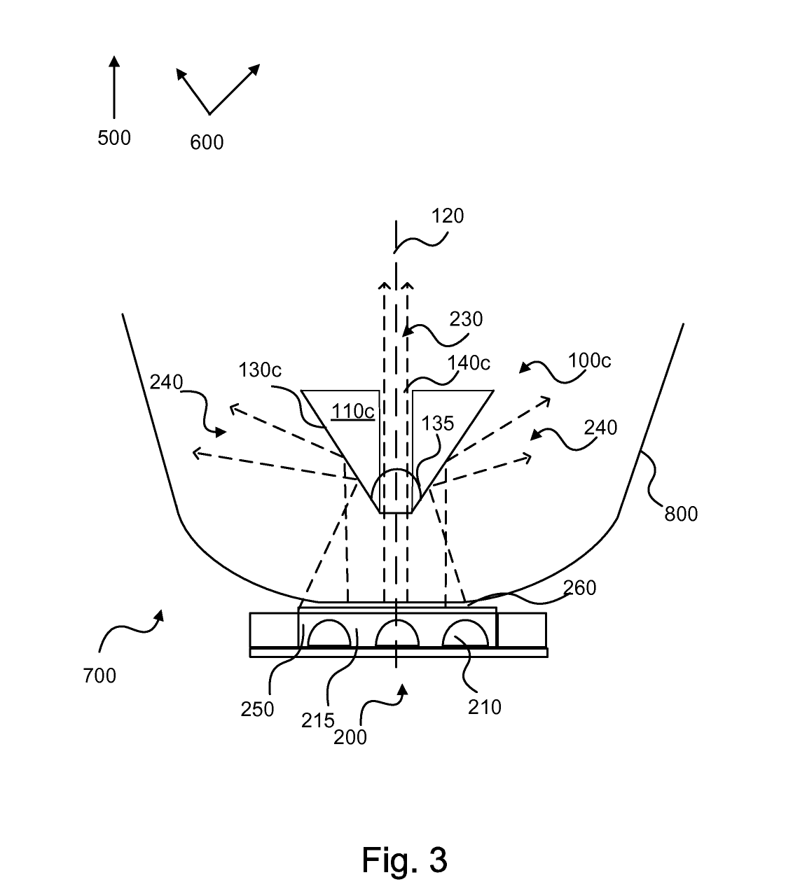

The light guides 100ac in FIGS. 1 and 3 have, as previously discussed, cone parts 110ac. These cone parts 110ac can, e.g., be attached to the reflector 800 or to a housing (not shown) of the luminaire 700. Methods can be used that are known to those skilled in the art of fitting optical elements in front of a light source. For instance, a steel bracket can be used.

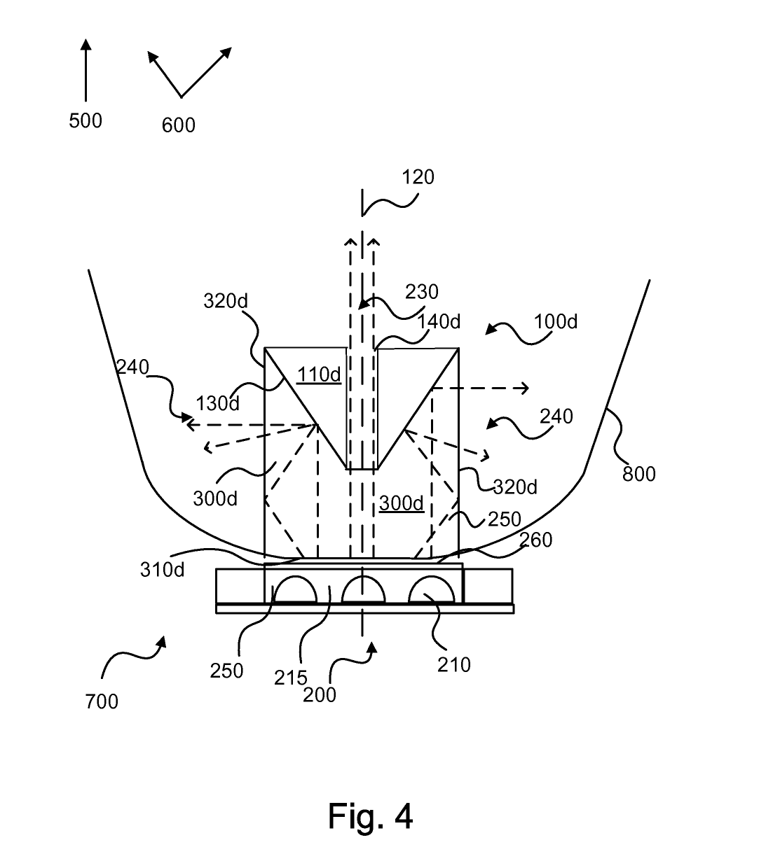

The light guides 100cd of FIGS. 3-4 comprise, in the center part of the cone part 110cd, a through opening 140cd such that light emitted from the light source 200 directed to the center of the cone part 110cd continues through the cone part 110cd in the first direction 500. Thus, the light guides 100cd are arranged to direct a minor part of the light 230 in the first direction 500.

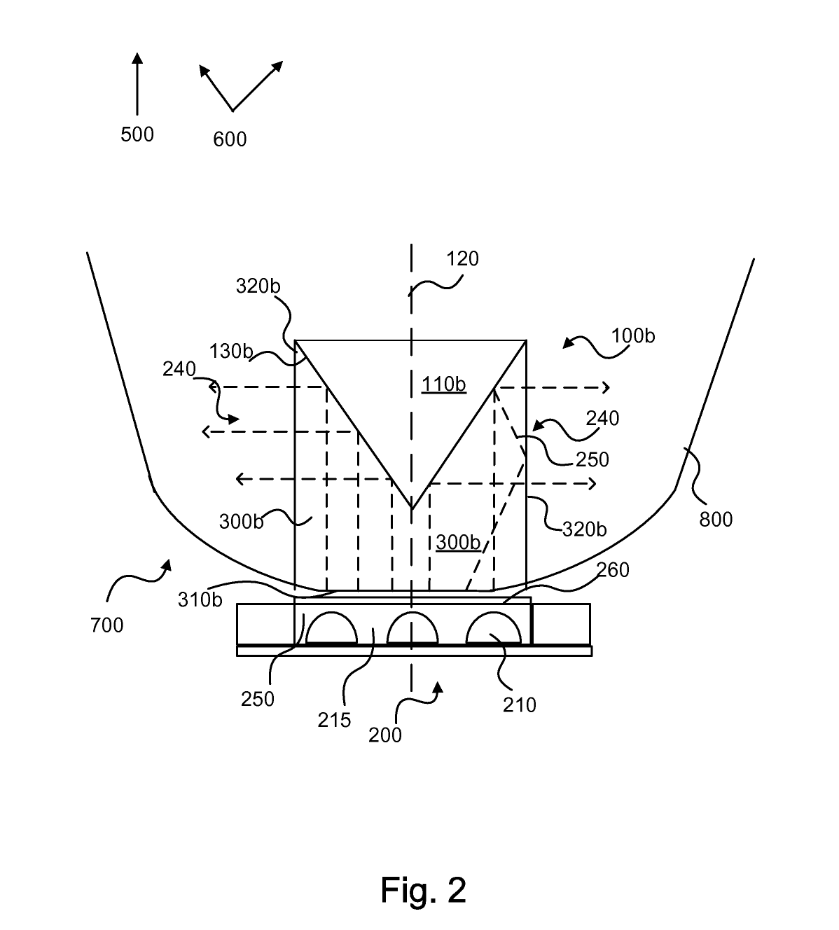

In FIGS. 2 and 4, the light guides 100bd comprise cylinder parts 300bd in the shape of a cylinder. Preferably, the cylinder parts 300bd provide total internal reflection. Total internal reflection is to be interpreted as that light reflected internally in the cylinder parts 300bd is reflected solely due to difference in refractive index between the light guide and the surrounding air, resulting in reflection without loss. Light emitted from the light source 200 enters the light guide 100bd through a base 310bd of the cylinder part 300bd. Light that is incident on the side walls 320bd in a direction close to the surface normal continues through the side walls 320bd towards the reflector 800. Light that is incident on the side walls 320bd at a large angle in relation to the surface normal is reflected (see, e.g., light ray 250. The larger the angle of incidence in relation to the surface normal, the more light is reflected.

The height at which the light from the light guide 100 reaches the reflector 800 is determined by the height of the cone part 110. This can be varied by either varying the height at which the cylinder part 110ac is attached, or by varying the height of the cylinder part 300bd.

The angle at which the light is emitted from the light guide 100ac is determined by the top angle 135 of the cone part 110ac.

In summary, the disclosed embodiments relate to a light guide 100a and a luminaire 700 including such a light guide 100a. The light guide 100a guides light emitted in a first direction 500 from a light source 200 comprising at least one light emitting diode 210. The light guide 100 directs a major part of the light in a second direction 600, wherein the first direction 500 is not equal to the second direction 600. The light guide 100a comprises a cone part 110a having a shape of a cone, and a center axis 120 of the cone part 110a is in the first direction 500. The light guide 100a can be used with reflectors 800 that have originally been manufactured for use with high intensity discharge lamps or halogen lamps but because of the light guide 100a, the reflectors 800 can be used together with light sources 200 in the form of at least one light emitting diode 210.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage.

Any reference signs in the claims should not be construed as limiting the scope.

1. A luminaire, comprising:
a light source comprising at least one light emitting diode and a mix box,
a light guide for guiding light emitted in a first direction from the light source,
wherein the light guide is arranged to direct a major part of the light in a second direction, wherein the first direction is not equal to the second direction,
wherein the light guide comprises a cone part having a shape of a cone, wherein a center axis of the cone part is substantially aligned with the first direction, and wherein the cone part has a circumferential surface.

2. The luminaire according to claim 1, wherein the light emitted from the light source is arranged to be reflected on the circumferential surface of the cone part such that after the reflection, the light is directed in the second direction.

3. The luminaire according to claim 2, wherein the circumferential surface comprises a reflective coating.

4. The luminaire according to claim 3, wherein the reflective coating is at least one from the group of a specularly reflective, and diffusively reflective.

5. The luminaire according to claim 4, wherein the circumferen-tial surface is at least one from the group of segmented and facetted.

6. The luminaire according to claim 5, wherein the light guide is arranged to direct a minor part of the light in the first direction.

7. The luminaire according to claim 6, wherein a center of the cone part comprises a through opening such that light emitted from the light source directed to the center of the cone part continues through the cone part in the first direction.

8. The luminaire according to claim 7, wherein the cone part is arranged in a cylinder part in the shape of a cylinder.

9. A luminaire according to claim 8, wherein the cylinder part is arranged to provide total internal reflection.

10-11. (canceled)

12. The luminaire according to claim 1, wherein the light source further comprises a diffusive exit window.

13. The luminaire according to claim 12, wherein the light source comprises a high intensity discharge lamp or halogen lamp, the luminaire further comprising a reflector.
